(19) United States
(12) Patent Application Publication
(10) Pub. No.: US 2023/0408114 A1
(43) Pub. Date: Dec. 21, 2023

(54) PORTABLE AIR CONDITIONER COMPRISING A TRANSPORT UNIT AND TRANSPORT UNIT

(71) Applicant: TRUMA GERAETETECHNIK GMBH & CO. KG, Putzbrunn (DE)

(72) Inventors: Daniel PLESS, Putzbrunn (DE); Mathias VENSCHOTT, Putzbrunn (DE); Peter WICKELMAIER, Putzbrunn (DE)

(21) Appl. No.: 18/036,764

(22) PCT Filed: Nov. 12, 2021
(86) PCT No.: PCT/EP2021/000142

§ 371 Date: May 12, 2023

(30) Foreign Application Priority Data
Nov. 13, 2020 (DE) 10 2020 006 967.3

(51) Int. Cl. F24F 1/04; F24F 1/028

(52) U.S. Cl. CPC F24F 1/04; F24F 1/028

(57) ABSTRACT

Example embodiments relate to a portable air conditioner including a transport unit. An interior space of the transport unit is adapted to be tempered by the air conditioner and can accommodate the air conditioner for transport. Furthermore, example embodiments relate to a transport unit.

### FIELD OF DISCLOSURE

Example embodiments relate to a portable air conditioner for tempering air comprising a transport unit. Furthermore, example embodiments relate to a transport unit for an air conditioner.

### BACKGROUND

In the prior art, air conditioners are known which temper, i.e. cool or heat, rooms of houses or, for example, of caravans or mobile homes. For this purpose, the air conditioners are permanently installed to or on the houses or the vehicles. Furthermore, portable (alternative designation: mobile) air conditioners are known, which are carried to an area to be cooled, for example. Therefor, these air conditioners are lighter in weight and also have a housing which does not necessarily have to be irreversibly fixed to a roof or wall.

### SUMMARY

The object on which example embodiments is based is to propose an advantageous portable air conditioner.

Example embodiments achieve the object on the one hand by a combination of a portable air conditioner and a transport unit, and on the other hand by a transport unit for a portable air conditioner.

Example embodiments achieve the object by a portable air conditioner for tempering air, comprising a transport unit, wherein the air conditioner has at least one housing having an air inlet and an air outlet, and wherein the air conditioner is configured so as to temper air conveyed from the air inlet to the air outlet. An air outlet is adapted to be reversibly connected to the transport unit, wherein the transport unit is thermally insulated, wherein the transport unit encloses an interior space, wherein the interior space of the transport unit is adapted to be tempered by air tempered by the air conditioner, and wherein the transport unit and the air conditioner are configured and adjusted to each other such that the air conditioner is adapted to be reversibly inserted into the transport unit. Preferably, the transport unit supports a transport of the air conditioner by allowing the inserted air conditioner to be carried.

According to example embodiments, an interior space of the transport unit can thus be tempered by the air conditioner and the air conditioner can be transported in the transport unit. It is known to use compressor refrigerators, thermoelectric refrigerators and absorber refrigerators for cooling food. In addition, refrigerators based on evaporative cooling are sometimes used. These refrigerators are characterized by fixed external dimensions. With a higher capacity for goods to be cooled, the external dimensions also increase. The advantage of a mobile and flexible cooling possibility, without requiring substantially more storage space, results here from a combination of the portable air conditioner with a container. The container is referred to as a transport unit, insofar as it allows the transport of objects in an interior space as well as the transport of the air conditioner itself. The transport unit is preferably foldable, collapsible or pluggable and takes up only a small volume in the folded or possibly disassembled state. According to the invention, it is thus provided that the tempered output air from the air conditioner is conducted into a docking container (i.e. the transport unit), the interior space of which is tempered (e.g. cooled) by this air. In one configuration, the transport unit is a bag which is preferably thermally insulated. The bag is configured such that it can be used to store the air conditioner.

One configuration provides that the air inlet of the air conditioner is adapted to be reversibly connected to the transport unit. In this configuration, the air outlet and the air inlet of the air conditioner are connected to the transport unit so that the air conditioner supplies tempered air to the transport unit and removes air to be tempered from the transport unit. An alternative or complementary configuration includes that at least one temperature sensor for controlling the air conditioner is integrated or adapted to be inserted into the transport unit. Based on the temperature detected by the temperature sensor, the air conditioner can thus be controlled in this configuration. An alternative or complementary configuration consists in that the transport unit is adapted to be connected—preferably magnetically—to two hoses for the supply and removal of air. An alternative or complementary configuration consists in that the transport unit has a component, that the component serves as a lid, side or bottom, that the component comprises the interior space of the transport unit, that the component is configured to be at least partially double-walled, and that the component has openings to the interior space of the transport unit. In this configuration, the tempered air is introduced into the interior space through the openings. A complementary configuration consists in that the component is adapted to be connected to a hose. In this configuration, the tempered air reaches said component via the hose and enters the interior space through the openings. An alternative or complementary configuration consists in that the air inlet and/or the air outlet of the air conditioner are/is adapted to be detachably (and thus also reversibly) connected—preferably magnetically—to a hose.

Furthermore, example embodiments achieve the object by a transport unit for a portable air conditioner, wherein the transport unit is thermally insulated, wherein the transport unit encloses an interior space, and wherein the air conditioner is adapted to be reversibly inserted into the transport unit. The transport unit can thus serve as a cooling space by being reversibly connected to the air conditioner accordingly. Furthermore, the air conditioner can be transported in the transport unit.

The configurations discussed above and below with regard to the combination of an air conditioner and a transport unit also apply accordingly to the transport unit. Conversely, the configurations and discussions regarding the transport unit also apply to the combination of an air conditioner and a transport unit.

In one configuration, a quick connector for the hoses is provided on the transport unit to contact the air conditioner. In one configuration, a temperature sensor for controlling the air conditioner is integrated in the transport unit. In one configuration, the transport unit is a cooling box. In one configuration, air is passed through the transport unit to contribute to cool the environment. In a further configuration, the air circulates within the transport unit to achieve accordingly lower or higher temperatures. Further, in one configuration, the two aforementioned configurations are combined alternately or as needed. In one variant, the transport unit is made of a material which can be stowed in a space-saving manner, and/or the geometry allows the transport unit to be inflated by the pressure of the outflowing air. In one configuration, a plurality of transport units can be coupled to each other to increase the available storage space. In one configuration, the dimensions of the interior space of the transport unit can be changed, for example, by pulling the transport unit apart. In one configuration, the transport unit has a component which serves as a wall, lid or bottom, for example, and thus also comprises the interior space. This component comprising the interior space is configured to be at least partially double-walled and has openings to the interior space, for example to ensure better distribution of the tempered air.

One configuration of the transport unit provides that the transport unit has a support structure. The structure is, for example, a type of support.

### BRIEF DESCRIPTION OF DRAWINGS

In detail, there are a plurality of possibilities for designing and further developing the air conditioner according to the invention and the transport unit according to the invention. For this purpose, in addition to the above explanations, reference is made to the description below of example embodiments in connection with the drawing, in which:

FIG. 1 shows a schematic representation of a transportable air conditioner,

FIG. 2 shows a section through part of a configuration of an air conditioner with the portion for connection to a hose and an additional component,

FIG. 3 shows a spatial representation of a further configuration of an air conditioner with a removed condensate container,

FIG. 4 shows two states of an air conditioner in relation to the positioning of the cover device,

FIG. 5 shows a section through an air conditioner with one configuration with respect to a first design of the socket configuration,

FIG. 6 shows a section through a further design of the socket configuration,

FIG. 7 shows a section through a schematic representation of an air conditioner with laterally interchangeable components for switching between heating and cooling,

FIG. 8 shows a spatial representation of an arrangement with a drying chamber and an air conditioner,

FIG. 9 shows a spatial representation of two configurations of a transport unit, and

FIG. 10 shows a spatial representation of a further configuration of the air conditioner.

### DETAILED DESCRIPTION OF EXAMPLE EMBODIMENTS

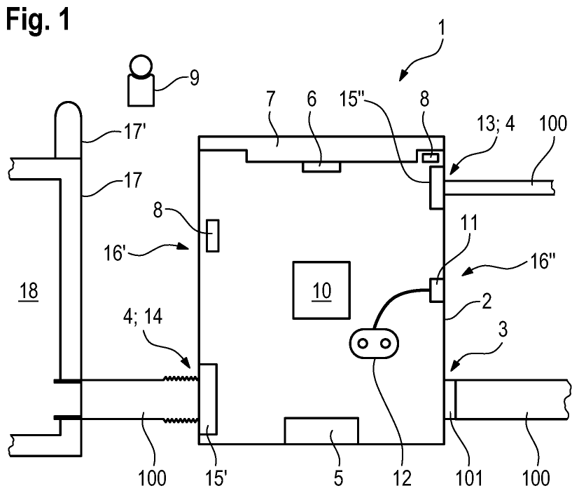

FIG. 1 schematically shows the structure of an air conditioner 1 for tempering—either cooling or heating—air. For this purpose, there are at least one air inlet 3, to which, for example, the room air is supplied, and two air outlets 4. The two air outlets 4 are, on the one hand, a cold air outlet 14 and a warm air outlet 13. Via the cold air outlet 14, the cooled air is discharged and via the warm air outlet 13, the air to which the thermal energy of the cooled air has been transferred is discharged. In the case of the cold air outlet 14, it is also indicated here that it is an extendable hose the length of which can be changed if required.

A hose (alternatively: tube) 100 is respectively connected to the one inlet 3 and the two outlets for guiding the air. This is done here via a magnetic connection. Magnetic and metallic rings are for example combined with each other. This type of contact is realized such that an additional component 101 is located between the input or output and the hose. This can be seen here for the air inlet 3, adjoined, for example, by a filter as an additional component 101 and then by a hose 100. Due to the magnetic connection, the contact can in particular be released without tools.

The air to be cooled usually contains moisture which settles on cool components of the air conditioner 1 as condensate. To ensure that the condensate can be easily removed, a condensate container 5 is provided which can be moved relative to the housing 2 of the air conditioner 1. In particular, part of the interior of the air conditioner 1 is thus made accessible such that moisture can also be reliably removed from locations in the housing 2. Alternatively, the condensate container 5 can be removed from the housing 2. In particular, the accessible components or parts of the air conditioner 1 are very relevant in that safe drying or cleaning can take place.

To simplify the transport of the air conditioner 1, a carrying handle 6 which can preferably be pivoted out or in is provided on the upper side. Above the carrying handle 6, there is a cover device 7, which is exemplarily designed as a seating surface. The cover device 7 is fixed by a magnet 8. On the side, there is a further magnet 8 which allows the cover device 7 to be fixed to the side. In one configuration, the entire side of the housing is configured to be magnetic.

In the illustrated example embodiment, a microphone 9 is arranged remotely from the air conditioner 1 to determine the volume in the environment. The measured signals are therefore transmitted to the control unit 10 —either as raw signals or as signals processed with respect to the volume. The control unit 10 deduces therefrom whether it is, for example, night. Based on this determination of a statement about the ambient conditions, the control unit 10 controls the air conditioner 1 or individual components of the air conditioner 1 so that a desired noise condition is achieved. For example, if it is detected that the environment is rather quiet, the compressor output is for example reduced. The output and thus the noise level is thus adapted to the noise environment.

The air conditioner 1 requires electrical power for its tempering activity, which is available therefor via a power connection point 11. To enable the operation of further electrical devices, the power connection point 11 is continuously connected to an integrated socket as a power output unit 12, which is indicated here by the solid line. Thus, the air conditioner 1 receives the necessary electrical power and a voltage source is still available.

As already explained, the air conditioner 1 has a cooling air outlet 14 and a warm air outlet 13. They are both respectively connected via a connection component 15′, 15″ to one side 16′, 16″ of the housing 2 and to the air paths inside the housing 2. In a variant not shown here, the connection components 15′, 15″ each comprise a larger portion of the sides 16′, 16″, so that in one variant the air inlet 3 is also fastened via one of the connection components 15′, 15″. The connection components 15′, 15″ and the respective interfaces on the two sides 16′, 16″ are designed such that a reversible switching between the two sides 16′, 16″ is possible. A reversing of the air conditioner 1 and thus switching between heating and cooling is thus also possible without any problems.

The air conditioner 1 is a portable unit. It thus has a housing 2 which is self-contained and which also has such stability that it can stand securely without being fixed to a wall or roof. The weight is also such that it can be carried by a human being, for example. This mobile air conditioner 1 is further connected to a transport unit 17 via a hose 100. In particular, the cooling air outlet 14 is connected to the interior space 18 of the transport unit 17. This results in the air conditioner 1 cooling the transport unit 17 so that foodstuffs can be transported therein, for example. The interface of the transport unit 17 for contacting the hose 100 is preferably designed to be as simple as possible and allows a closure after the cooling process, so that the cool interior air cannot escape as far as possible. The transport unit 17 is dimensioned such that the air conditioner 1 can be accommodated and carried in the transport unit 17, for example. For this purpose, a support 17′ of the support unit 17 designed as a bag is indicated here.

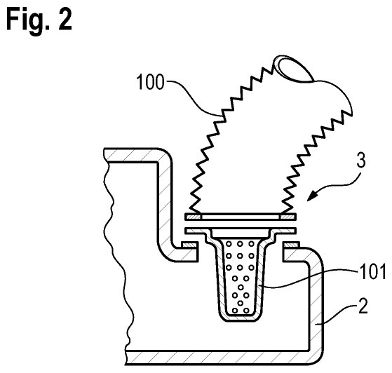

FIG. 2 shows as an example how a hose 100 is attached to the air inlet 3 via a magnetic and a metallic ring. An additional component 101 is clamped between the two components, which in this case is an air filter.

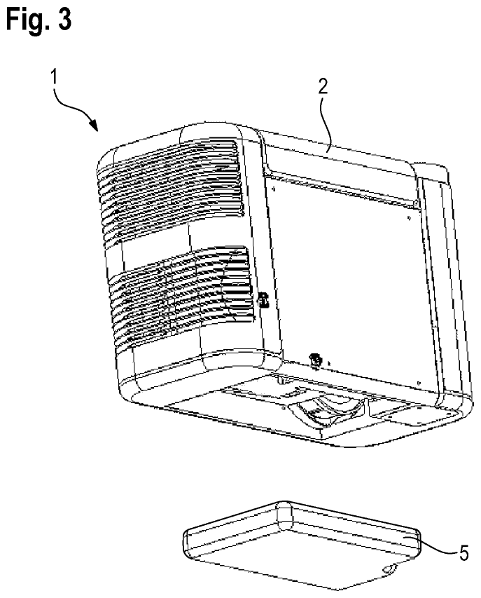

FIG. 3 shows a view of the underside of the housing 2 in the state in which the condensate container 5 has been removed. The condensate container 5 is here the bottom of the housing 2, so that the removal of the container 5 allows to reach and clean or dry all the components of the air conditioner 1 which face the lower side.

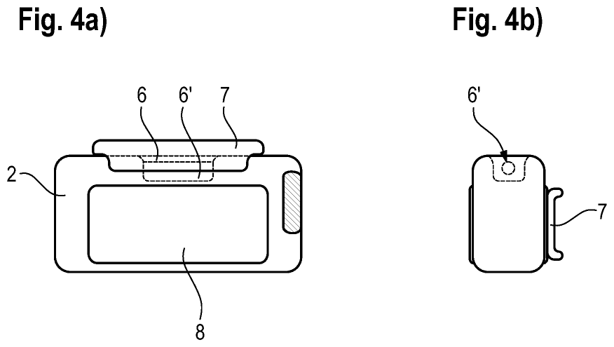

FIG. 4 a) shows how the cover device 7, which is designed as a seating surface, is located on the upper side of the housing 2 and thus also above the folded-in carrying handle 6. In particular, the carrying handle 6 is located here in a cavity 6′ of the housing 2. In FIG. 4 b), the cover device 7 is reversibly fixed to one side of the housing 2 using magnetic force (here realized by a magnetic portion 8). The carrying handle 6 is thus accessible in the recess 6′.

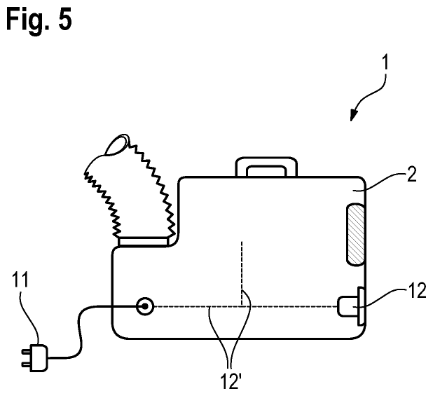

FIG. 5 shows an electrical feature of the air conditioner 1. The power supply is provided via the power connection point 11, which is designed here as an appliance connector. Furthermore, an integrated socket is provided as a power output unit 12, via which electrical voltage can be made available to electrical devices. Within the air conditioner 1 and thus also within the housing 2, electrical contacts 12′ are provided which electrically connect the power connection point 11 and the power output unit 12 as well as the individual electronic components of the air conditioner 1 with each other.

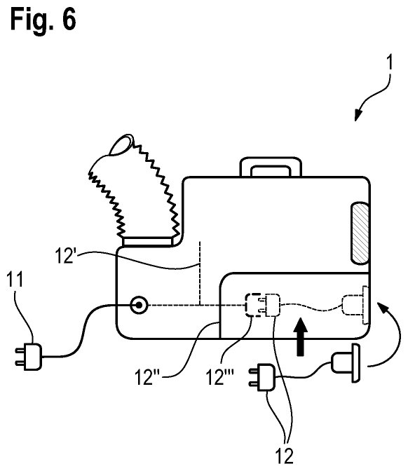

In the configuration of FIG. 6, which is an alternative configuration to FIG. 5, the power output unit 12 is given via a retrofittable plug which is plugged into a socket 12′″ located behind a flap 12″ in the housing 2.

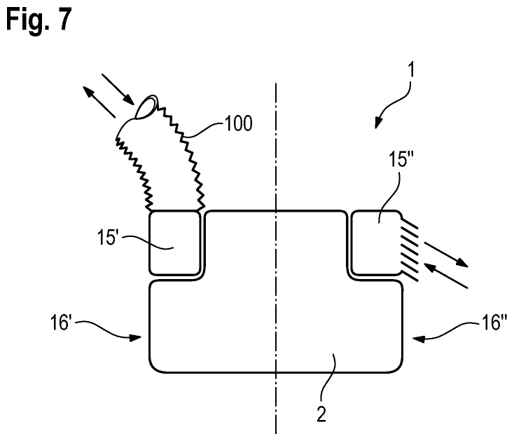

FIG. 7 shows how a rotation of the housing 2 by 180° about the vertical axis (indicated by the dash-dotted line) causes the heating and cooling functions to be switched. For this purpose, the two connection components 15′, 15′ are adapted to be reversibly connected to both sides 16′, 16″ of the housing 2. Since the air conditioner 1 outputs the warm air on one side 16′ and the cold air on the other side 16″, the type of air is also changed by the rotation. In particular, this can also be done by exchanging the connection components 15′, 15″, both of which can be attached to both sides 16′, 16″ of the housing 2. It can be seen here that a connection component 15′ is connected to a hose 100. In an alternative configuration, the connection component 15′ comprises the hose 100. The other connection component 15″ is configured in a lamellar shape and thus also allows the air to be blown out directly. The arrows indicate that the air can move in both directions depending on the application. It is thus drawn once and expelled once—depending on the operating state of the air conditioner and/or depending on which side 16′, 16″ which connection component 15′, 15″ is located on.

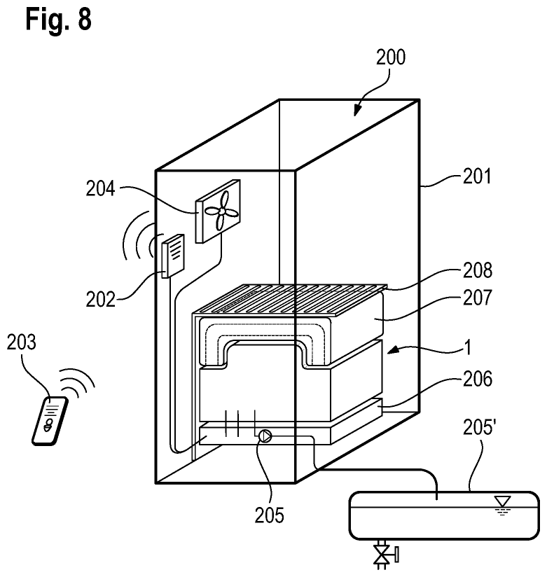

Finally, FIG. 8 shows an arrangement with an enclosing structure 201 which encloses a drying chamber 200. Here, the enclosing structure 201 has a plurality of wall elements. An air conditioner 1 according to one of the above configurations is placed in the drying chamber 200 and serves to dry the air.

Thus, when moist objects are introduced into the drying chamber 200, they are dried by the air conditioner 1. A humidity sensor 202 which is connected to a mobile terminal 203 is located in the drying chamber 200. Furthermore, there is a circulating-air fan 204 and a condensate pump 205, which is connected to the waste-water tank 205′ of the vehicle in which the arrangement is located. Furthermore, an interface 206 for electrical contact is located below the air conditioner 1. A molded part having an air duct 207 and a sound insulation 208 is present above the air conditioner 1.

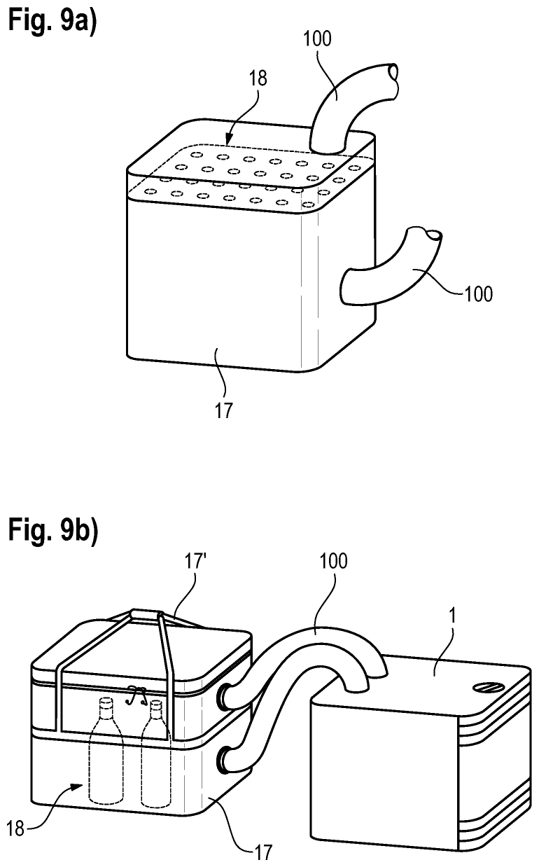

FIG. 9 shows two configurations of the transport unit 17. In FIG. 9 a) it can be seen that the transport unit 17 is connected to two hoses 100 for the supply and removal of the tempered air. The upper side of the transport unit 17 is here configured so as to be double-walled. The outside is only connected to the hose 100. The inside of the lid is provided with a plurality of recesses through which the tempered air is guided. FIG. 9 b) shows how the transport unit 17 is coupled to the air conditioner 1 via two hoses 100. The transport unit 17 has a support structure 17′. It is indicated that the interior space 18, which is tempered by the air conditioner 1, contains bottles as objects to be cooled.

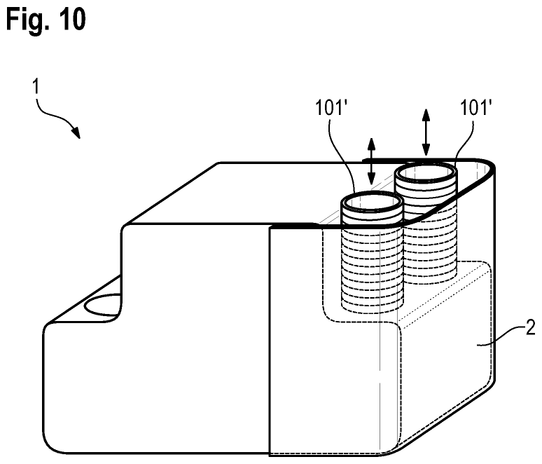

FIG. 10 shows an air conditioner 1 which has integrated hoses 101 of variable length. The hoses 101′ serve to supply or remove air. The length variability is indicated by the double arrows. The state of rest, i.e. the state in which the air conditioner 2 is not used is shown. In this state, the hoses 101′ are in a rest position and thus also have the smallest length extension. It can be seen that the two hoses 101′ are located on a lateral shoulder of the housing 2. The depth of the housing shoulder and the length of the hoses 101′ in the resting state are matched to each other such that the hoses 100′ are located within the outer contour of the housing 2 and thus do not protrude beyond the outer contour here indicated. Thus the air conditioner 1 as a whole can be easily stowed or also transported.

1. A portable air conditioner for tempering air, comprising:
a transport unit,
wherein the air conditioner has at least one housing having an air inlet and an air outlet,
wherein the air conditioner is configured so as to temper air conveyed from the air inlet to the air outlet,
wherein the air outlet is adapted to be reversibly connected to the transport unit,
wherein the transport unit is thermally insulated,
wherein the transport unit encloses an interior space,
wherein the interior space of the transport unit is adapted to be tempered by air tempered by the air conditioner,
wherein the transport unit and the air conditioner are configured and adjusted to each other such that the air conditioner is adapted to be reversibly inserted into the transport unit,
wherein the transport unit is a bag, and
wherein the transport unit has a support structure in the form of a support.

2. The air conditioner comprising a transport unit according to claim 1,
wherein the air inlet of the air conditioner is adapted to be reversibly connected to the transport unit,
wherein the transport unit is adapted to be connected to two hoses for the supply and removal of air, and
wherein at least one of the air inlet of the air conditioner or the air outlet of the air conditioner is adapted to be detachably connected to a hose.

3. The air conditioner comprising a transport unit according to claim 1,
wherein the transport unit has a component,
wherein the component serves as a lid, a side or a bottom,
wherein the component comprises the interior space of the transport unit,
wherein the component is configured to be at least partially double-walled,
wherein the component has openings to the interior space of the transport unit, and
wherein the component is adapted to be connected to a hose.

4. (canceled)

5. (canceled)

6. (canceled)

7. (canceled)

8. (canceled)

9. The air conditioner comprising a transport unit according to claim 2,
wherein the transport unit has a component,
wherein the component serves as a lid, a side or a bottom,
wherein the component comprises the interior space of the transport unit,
wherein the component is configured to be at least partially double-walled,
wherein the component has openings to the interior space of the transport unit, and
wherein the component is adapted to be connected to a hose.
